(19) United States
(12) Patent Application Publication
(10) Pub. No.: US 2020/0401065 A1
(43) Pub. Date: Dec. 24, 2020

(54) IMAGE SENSOR

(71) Applicant: Hewlett-Packard Development Company, L.P., Spring, TX (US)

(72) Inventors: Ido Finkelman, Ness Ziona (IL); Rivay Mor, Ness Ziona (IL); Eitan Kichli, Ness Ziona (IL); Iliya Shahamov, Ness Ziona (IL); Pavel Shulga-Raz, Ness Ziona (IL)

(73) Assignee: Hewlett-Packard Development Company, L.P., Spring, TX (US)

(21) Appl. No.: 16/965,026

(22) PCT Filed: Mar. 16, 2018
(86) PCT No.: PCT/US2018/022938

§ 371 Date: Jul. 27, 2020

(51) Int. Cl. G03G 15/10; G03G 15/01; G03G 15/00

(52) U.S. Cl. CPC G03G 15/105; G03G 15/5062; G03G 15/0131

(57) ABSTRACT

An example printer comprises an impression cylinder arranged to receive an impression medium thereon and an intermediate transfer member arranged to transfer printing fluid onto a substrate received on the impression medium. The printer further comprises an image sensor arranged to sense an accumulation of printing fluid on the impression medium as sensor data and a controller. The controller is configured to determine, based on the sensor data, an accumulation level of the printing fluid on the impression medium and determine if the accumulation level meets a threshold.

### BACKGROUND

Printers, such as liquid electrophotographic printers, form images on a substrate. A liquid electrophotographic printer may use digitally controlled lasers to create a latent image on a charged surface of an imaging element such as a photo imaging plate (PIP). In this process, a uniform static electric charge is applied to the photo imaging plate and the lasers dissipate charge in certain areas creating the latent image in the form of an invisible electrostatic charge pattern conforming to one colour separation of the image to be printed. A printing fluid, such as ink, is then applied and attracted to the partially-charged surface of the photo imaging plate, recreating a separation of the desired image.

In certain liquid electrophotographic printers, a transfer member, such as an intermediate transfer member (ITM) is used to transfer developed images to a print substrate. For example, a developed image, comprising printing fluid, may be transferred from the photo imaging plate to a transfer blanket of an ITM. From the ITM, the printing fluid is transferred to a substrate, which is placed into contact with the transfer blanket.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a diagram of a printer according to an example;

FIG. 2 is a side view of a portion of the printer depicted in FIG. 1;

FIG. 3 is a top-down view of the portion of the printer depicted in FIG. 2;

FIG. 4 shows a plot of an accumulation level of printing fluid on an impression medium against a number of impression events according to a first example;

FIG. 5 shows a plot of an accumulation level of printing fluid on an impression medium against a number of impression events according to a second example;

FIG. 6 shows a plot of an accumulation level of printing fluid on an impression medium along an axis according to a third example;

FIG. 7 shows a plot of an accumulation level of printing fluid on an impression medium along an axis according to a fourth example;

FIG. 8 is a top-down view of a portion of the printer depicted in FIG. 1 and an image recorded by the image sensor;

FIG. 9 shows a flow diagram of a method of monitoring an impression medium according to an example; and

FIG. 10 shows a diagrammatic representation of an example set of computer-readable instructions within a non-transitory computer-readable storage medium.

### DETAILED DESCRIPTION

In an example printing system, the substrate is received on an impression cylinder when the substrate is brought into contact with the ITM. This contact causes one or more print separations to be transferred to the substrate from the transfer blanket. The substrate is therefore “nipped” between the ITM and the impression cylinder. The process of transferring printing fluid to a substrate may therefore be known as an “impression event”.

In some example printers, at least a portion of the impression cylinder's surface is covered by an impression medium, such as impression paper for example. This impression medium is mounted on the impression cylinder, and the substrate is received on top of the impression medium. Typically the impression medium remains on the impression cylinder for many impression events, before being replaced.

The impression medium helps protect the impression cylinder, the transfer blanket and the printed substrate from being damaged by printing fluid. For example, during operation of a printer, a substrate misfeed or other malfunction may occur, which results in a substrate not arriving on the impression cylinder. The transfer blanket of the ITM can become damaged if the printing fluid, such as ink, remains there for too long. To avoid this, the printing fluid should be transferred from the ITM. The ITM therefore deposits the printing fluid onto the impression medium rather than depositing directly onto the bare impression cylinder.

In another example, the print separations formed on the blanket may be misaligned with the substrate. This misalignment may be known as misregistration. Misregistration may be a result of the substrate slipping out of position, or as a result of high frictional forces stopping the substrate from moving into the correct position. As the ITM deposits the printing fluid, a portion of the fluid may be deposited onto the impression medium rather than the substrate.

In another example, the print separation may be larger than the printable area of the substrate, to ensure coverage to an edge of the substrate. In that case, a portion of the print separation may overlap the edge of the substrate and be deposited onto the impression medium.

In another example, “background” printing fluid particles can accumulate on the blanket across an area that is larger than the area of the substrate. These background particles may transfer to the impression medium, depending upon the substrate thickness and the pressure between the ITM and the impression cylinder as they are nipped together. As this background gradually accumulates on the impression medium, a layer of printing fluid may start to form at a typical rate of about 1 micron per 1,000 impressions.

These, and other processes, can cause printing fluid to build up on the impression medium. As the impression medium becomes dirty, it's performance can deteriorate. For example, the impression medium may become overly tacky, and/or its ability to absorb printing fluid reduces. Furthermore, the printing fluid may come into contact with substrates which are received on the impression medium. For example, in duplex printing a printed surface of the substrate can contact printing fluid on the dirty impression medium, which can adversely affect the quality of the printed image. Further, the frictional forces between the substrate and the fluid on the impression medium can eventually cause dried printing fluid to peel off. Detached flakes can then transfer back to the printed substrate which can damage the print quality or can travel further into the printer. These may inflict mechanical damage, such as dents or scratches to the blanket and PIP, which may shorten their life span.

Accordingly, to avoid these issues, an example printer as described herein provides a method of automatically monitoring the buildup of printing fluid which accumulates on the impression medium.

An example printer therefore comprises an impression cylinder arranged to receive an impression medium thereon, an intermediate transfer member arranged to transfer printing fluid onto a substrate received on the impression medium, and an image sensor arranged to sense an accumulation of printing fluid on the impression medium as sensor data. The printer further comprises a controller, configured to determine, based on the sensor data, an accumulation level of the printing fluid on the impression medium, and determine if the accumulation level meets a threshold. The threshold may be a predetermined threshold which indicates that the impression medium is dirty, for example. The image sensor is therefore used to monitor the accumulation of printing fluid on the impression medium. An image sensor provides a repeatable, accurate and quantitative apparatus for monitoring the impression medium.

Throughout this description, the “accumulation level” corresponds to the dirtiness of the impression medium. An impression medium which has accumulated more printing fluid has a higher accumulation level and is considered dirtier than an impression medium having a lower accumulation level.

The example printer can detect when the impression medium has become dirty, without interfering with the work flow. In current systems, printer operators are used to monitor the impression medium by accessing the interior of the printer, which means that the work flow can be interrupted. Further, in these current systems, the operator may not always check the dirtiness of the impression medium as often as it should be. Further still, it is difficult for an operator to visually determine the dirtiness of the impression medium. This can lead to the operator replacing the impression medium too often, or not often enough. The example printer may therefore save time, boost productivity, prevent replacements from occurring to often, and/or reduce damage to the printer and/or printed substrate.

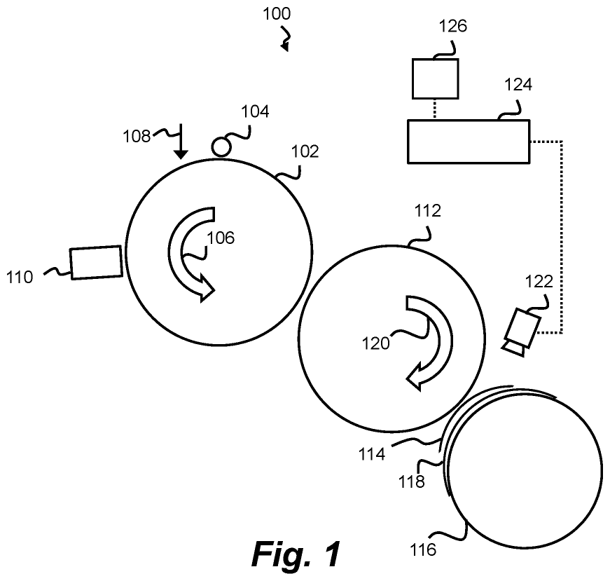

An example printer 100 is depicted in FIG. 1. According to the example of FIG. 1, a latent image is formed on a photo imaging plate (PIP) 102 by rotating a clean, bare segment of the photo imaging plate 102 under a charging element 104. The photo imaging plate 102 in this example is cylindrical in shape, and is constructed in the form of a drum which rotates in a direction of arrow 106. In other examples the photo imaging plate may be of another form, such as a belt. The charging element 104 may include a charging device, such as corona wire, a charge roller, scorotron, or any other charging device. A uniform static charge is deposited on the photo imaging plate 102 by the first charging element 104. As the photo imaging plate 102 continues to rotate, it passes an imaging unit 108 where one or more laser beams dissipate localized charge in selected portions of the photo imaging plate 102 to leave an invisible electrostatic charge pattern that corresponds to the image to be printed, i.e. a latent image.

In the described example, printing fluid, such as ink, is transferred onto the photo imaging plate 102 by at least one image development unit 110. An image development unit may also be known as a Binary Ink Developer unit. There may be one image development unit 110 for each ink color. During printing, the appropriate image development unit 110 is engaged with the photo imaging plate 102. The engaged image development unit 110 presents a uniform film of ink to the photo imaging plate 102. The ink contains electrically-charged pigment particles which are attracted to the opposing charges on the image areas of the photo imaging plate 102. The photo imaging plate 102 now has a single color ink image on its surface, for example an inked image or separation.

The ink may be a liquid toner, comprising ink particles and a carrier liquid. The carrier liquid may be an imaging oil. An example liquid toner ink is HP ElectroInk™. In this case, pigment particles are incorporated into a resin that is suspended in a carrier liquid, such as Isopar™.

Returning to the printing process, the photo imaging plate 102 continues to rotate and the printing fluid is transferred to the ITM 112. In some examples, a transfer blanket resides on the outer surface of the ITM 112. The ITM 112 may rotate in the direction of the arrow 120.

Once transferred to the ITM 112, the printing fluid can be transferred to the substrate 114, which is received on, and is partially wrapped around, an impression cylinder/drum 116. Between the substrate 114 and an outer surface of the impression cylinder 116, is an impression medium 118. The impression medium 118 may be held in place on the surface of the impression cylinder 116 by fastening means (not shown). The impression medium 118 may partially, or fully wrap around the impression cylinder 116. The impression cylinder 116 can mechanically compress the substrate 114 in to contact with the ITM 112.

The printer system 100 may further comprise an image sensor 122 arranged to sense an accumulation of printing fluid on the impression medium 118. The image sensor may comprise a charge coupled device (CCD) or a Complementary Metal Oxide Semiconductor (CMOS) device for detecting photons within a field of view. In one example, the image sensor 122 is a camera. In another example, the camera is also used in a registration process. For example, the camera may be used to detect one or more registration marks printed onto the substrate which are used to determine whether individual separations received on the substrate are properly aligned.

A controller 124 controls part, or all, of the print process. For example, the controller 124 may control the rotation of the ITM 112 and PIP 102, the supply of printing fluid onto the PIP 102, and the supply of substrates 114 to the impression cylinder 116. Furthermore, the controller 124 may also be configured to control operation of the image sensor 122. It will be appreciated that the controller 124 can also control any other, or all of the components of the printer system 100. In some examples, the controller 124 is embodied in one or more separate controllers.

In one example, the image sensor 122 senses an accumulation of printing fluid on the impression medium 118 as sensor data. The sensor data may be stored in memory 126, either locally or remotely, which is accessible by the controller 124. The controller 124 may therefore be configured to access, or receive the sensor data, and determine from the sensor data an accumulation level of printing fluid present on the impression medium 118.

In some examples, the image sensor 122 is configured to monitor the impression medium continuously, or periodically. The image sensor 122 may be configured to monitor the impression medium during a print run or during non-printing cycles, when the impression medium is not covered by a substrate. These non-printing cycles, or null-cycles, may occur at the start or end of a print run, between print runs, or when the print run is momentarily paused.

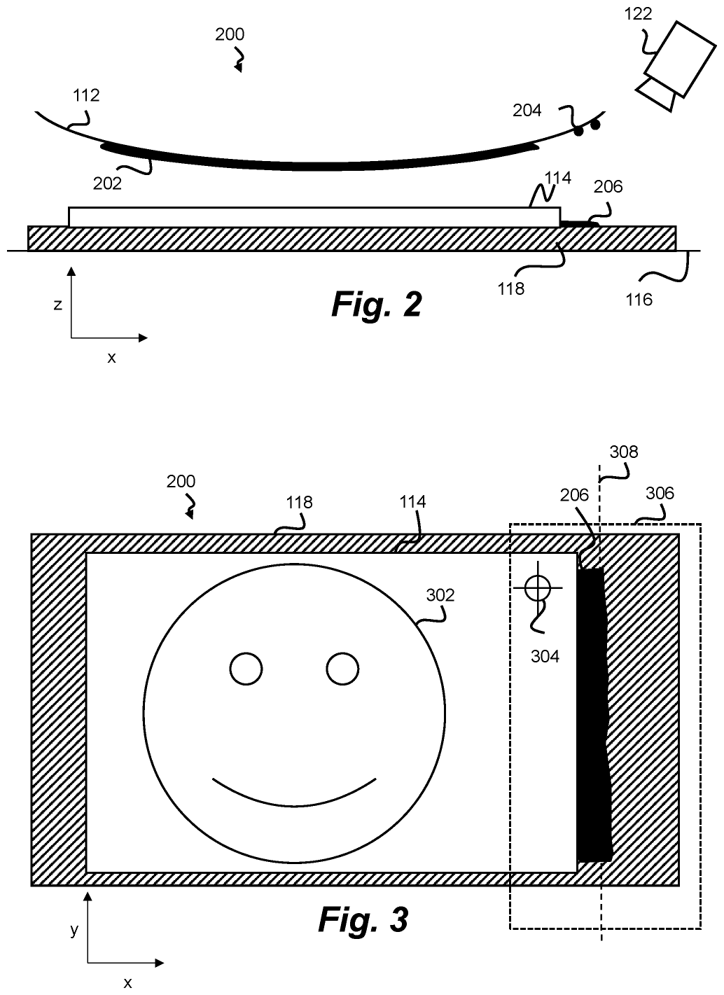

FIG. 2 depicts a side view of a portion 200 of the example printer 100 shown in FIG. 1. Here, a layer of printing fluid 202 is present on the ITM 112. This may correspond to one or more colour separations formed on the ITM 112. As shown, the printing fluid 202 is about to be deposited onto the substrate 114, which is positioned on top of the impression medium 118 which is secured on the impression cylinder 116. In this example, a number of background particles 204 are present on the blanket of the ITM 112. These are not to scale but are shown enlarged for illustration purposes.

FIG. 2 also depicts a region of printing fluid 206 which has accumulated on the impression medium 118. In one example, this accumulation may be due, at least in part, to background particles building up on the impression medium 118 over the course of many impression events. The image sensor 122 is positioned to monitor the buildup of printing fluid on the impression medium 118.

FIG. 3 depicts a top down view of the portion 200 shown in FIG. 2 after the printing fluid 202 has been deposited onto the substrate 114. The printing fluid forms an image 302 and a registration mark 304.

The rectangular area bounded by the dashed lines represents the field of view 306 of the image sensor 122. In some examples, the field of view 306 of the image sensor 122 is fixed. However, in other examples, the field of view is not fixed. For example, the image sensor 122 may be physically moved within the printer such that the image sensor 122 can image different areas within the printer. In another example, the image sensor 122 is physically fixed, but the position and/or size of the field of view 306 may be altered optically, via lenses. In one example, the image sensor 122 is also used in a registration procedure, such that the field of view 306 encompasses both the accumulated printing fluid 206 and the registration mark 304. By using the registration camera, the complexity, size, energy use, and/or cost of the printer can be reduced.

Although FIGS. 2 and 3 depict one region of accumulated printing fluid on the impression medium 118, there may be more than one region in some examples.

As mentioned, during a print run, or over the course of several print runs, printing fluid 206 may begin to accumulate on the impression medium 118. The sensor data, recorded by the image sensor 122, may be processed by the controller 124 to calculate, estimate, or determine an accumulation level of printing fluid on the impression medium 118. Pixel values recorded by the image sensor 122 may be used to determine the accumulation level. For example, the image sensor 122 may record an image made up of a number of pixels, where each pixel is associated with a pixel value.

An accumulation level can be determined from the pixel values directly, or the pixel values may be processed before an accumulation level is determined. Any number of image processing techniques may be used to determine an accumulation level.

In some examples, the accumulation level is determined based on an average of pixel values across a certain area of the image. However, in other examples, no averaging calculations are made. In some examples, the images are background subtracted to account for any intensity variations that may be present across the image.

In one example, the pixel values represent a grey-scale image with a dynamic range of 0 to 255 units, however lower or higher dynamic range image sensors can also be used. A lower unit value represents a lower intensity, and may appear as black, whereas a higher unit value represents a higher intensity, and may appear as white. In one example, the value between 0 and 255 may directly correspond to an accumulation level. For example, a lower value may represent a higher accumulation level and a higher value may represent a lower accumulation level. For instance, if the impression medium is white, and the printing fluid is black, a greyscale image of a “clean” impression medium would have relatively high pixel values. If printing fluid begins to accumulate on the impression medium, the pixel values in that region would become lower than previously measured. Accordingly, the pixel values can be used, by the controller 124, to determine an accumulation level. Other techniques may also be used.

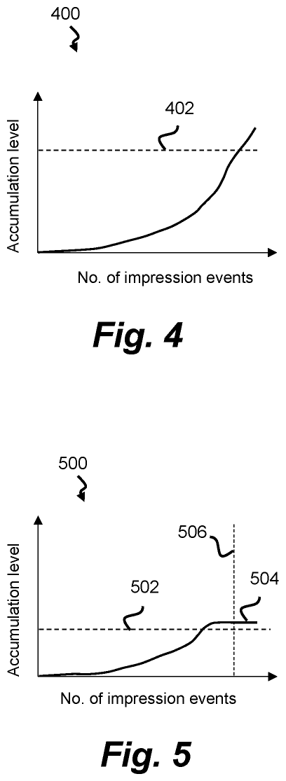

FIG. 4 shows a graph plotting the accumulation level of printing fluid on an impression medium 118 against a number of impression events. The graph shows that as more impression events occur, the accumulation level in a particular region increases as more printing fluid is deposited onto the impression medium 118. Dashed line 402 represents a threshold accumulation level.

In an example, the controller 124 is configured to continuously or periodically monitor the accumulation level. This accumulation level may be compared to a threshold accumulation level. If the accumulation level exceeds the threshold, the impression medium may be said to be “dirty”. For example, above the threshold, the accumulation level of printing fluid may begin to adversely affect the print quality, or other elements of the printer apparatus.

The threshold may be an empirically determined threshold. For example, it may be an accumulation level above which ink peel off is observed to occur. The threshold may be configurable by a user or manufacturer of the printer, or it may be automatically set. The user may be a person operating the printer or who maintains the printer. In one example, the threshold may be based on characteristics of print job that is being run. For example, the threshold may be dependent upon the type of printing fluid, the type of substrate, and/or the type of impression medium. In another example, the threshold may be dependent upon the image sensor 122 being used.

Regardless of how the threshold is set, once the controller 124 has determined that the accumulation level meets the threshold, any number of further procedures may be initiated.

In one example, the controller 124 is configured to set a flag to indicate that the impression medium is dirty responsive to determining that the accumulation level meets the threshold. Additionally or alternatively, the controller 124 is configured to notify a user of the printer that the impression medium 118 should be replaced responsive to determining that the accumulation level meets the threshold. Notifying a user may comprise sending a user a notification.

In one example, the controller 124 is configured to monitor the number of impression events that have occurred for the impression medium 118. In other words, the controller 124 may be configured to increment a count each time printing fluid is transferred from the ITM 112 to a substrate received on the impression medium 118. The controller 124 may therefore be configured to notify a user that the impression medium should be replaced responsive to determining that the accumulation level meets the accumulation level threshold and responsive to determining that the count meets a second threshold. The second threshold may therefore correspond to a number of impression events. The controller 124 thus performs two separate checks and notifies a user if both criteria are met. This may be beneficial to avoid the impression medium 118 being replaced too often. For example, an impression medium 118 may have an associated lifetime, where the lifetime is defined according to a number of impression events that it is designed to be used for. It may be undesirable to replace the impression medium if the lifetime has not been exceeded even if the impression medium is dirty. In one example, the second threshold is the lifetime of the impression medium. The second threshold may be several tens of thousands of impressions for example, such as 10,000, 20,000, 30,000 or higher.

The use of two thresholds may also be beneficial if the image sensor 122 is unable to accurately determine accumulation level beyond a certain limit, which is explained in more detail with reference to FIG. 5.

FIG. 5 shows a graph plotting the accumulation level of printing fluid on an impression medium 118 against a number of impression events. In this example, the image sensor 122 has a lower dynamic range than the image sensor used in FIG. 4. Again, the graph shows that as more impression events occur, the accumulation level generally increases as more printing fluid is deposited onto the impression medium 118. Dashed line 502 represents a threshold accumulation level. In this example, however, the sensor is unable to detect intensities below a certain limit, where a lower intensity corresponds to a higher accumulation level. As printing fluid continues to accumulate on the impression medium and the thickness of the fluid layer continues to increase, the image sensor cannot detect this increase in accumulation level due to the low dynamic range and/or low signal to noise ratio of the sensor. Therefore, beyond a certain limit, the accumulation level may appear to plateau. The plateau 504 is shown in FIG. 5. Had a higher dynamic range image sensor 122 been used instead, the plot would correspond to that shown in FIG. 4.

As a consequence of this effect, the accumulation level may not reach the threshold 402 that was set for FIG. 4. While a lower accumulation level threshold 502 can be used to estimate whether the impression medium 118 is dirty, this may be below the level at which the dirtiness of the impression medium has adverse effects. Accordingly, the second threshold associated with a number of impression events may be useful as a secondary check. Once both thresholds have been exceeded, it can be reasonably assumed that the impression medium 118 is dirty, and should be replaced. Furthermore, both thresholds 502, 506 are useful to avoid the impression medium 118 being replaced if it has exceeded the second threshold but is still not considered dirty.

As mentioned above, printing fluid accumulated on the impression medium 118 may begin to peel off. The controller 124 may therefore also be able to determine, based on the sensor data, that at least a portion of printing fluid has detached from the impression medium. In one example, the controller 124 notifies a user that the impression medium should be replaced responsive to determining that the peel off has been detected. In another example, the controller is configured to notify the user when it is determined that that at least a portion of printing fluid has detached from the impression medium and that the accumulation level meets the threshold.

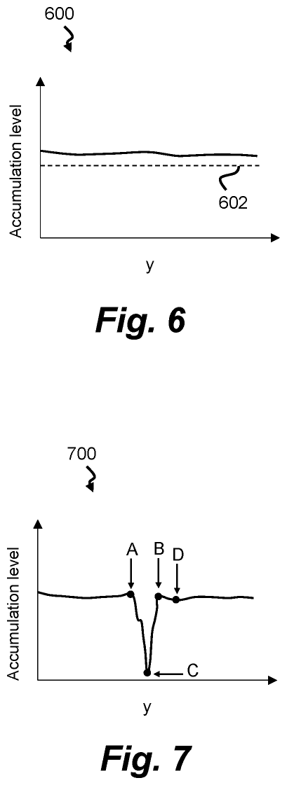

FIG. 6 shows a graph plotting the accumulation level of printing fluid on an impression medium 118 along an axis. For example, the axis may be axis 308, depicted in FIG. 3. In this example, the thickness of printing fluid, and therefore the accumulation level, is substantially uniform along the axis 308. This uniform distribution of printing fluid may be due to background particles, which are typically randomly distributed across the ITM 112 surface.

Peel off may be determined according to several techniques. In one example, the peel off may be determined by monitoring the accumulation over time, and by comparing the accumulation from a first time to the accumulation at a second, earlier time. FIG. 6 may therefore represent the accumulation level of printing fluid on an impression medium 118 at the second time, and FIG. 7 may represent the accumulation level along the axis 308 of the same impression medium at the first, later time. Between positions A and B, shown in FIG. 7, the printing fluid has peeled off and detached from the impression medium 118. Thus, by comparing the data from both times, it can be determined if the accumulation level at the later time is less than the accumulation level at a second earlier time. From this comparison, it can be deduced that at least a portion of printing fluid has detached from the impression medium 118.

In other example, the peel off may be determined based on accumulation level data corresponding to a single time. For example, based on FIG. 7 alone, it may be determined that at least a portion of printing fluid has detached by determining that the accumulation level of the printing fluid on the impression medium is non-uniform across a region of the impression medium. For example, the controller 124 may be configured to calculate the gradient of the accumulation level plot between adjacent points along the axis 308. The magnitude of the gradient between points A and C will be greater than the magnitude of the gradient between points B and D, for example. A large magnitude gradient may therefore be an indication that peel off has occurred since the ink accumulation may be assumed to be uniform. Other techniques for determining non-uniformity may also be used.

As mentioned, the controller 124 may be configured to notify a user that the impression medium should be replaced based on different criteria. A user may be notified via a user interface of a computing device used to control the printer, for example. Additionally, or alternatively, an audible, or another type of visual alert may be used to notify the user. In one example, notifying a user that the impression medium should be replaced comprises forbidding further printing. For example, the current print run may be stopped or paused, or it may be allowed to finish but future print runs may be forbidden from beginning. Printing may be allowed to resume once the impression medium 118 has been replaced.

In one example, the controller 124 may determine that the impression medium has been replaced when it detects that the accumulation level no longer meets the threshold. For example, the controller may be monitoring the accumulation level of a first impression medium and, based on the sensor data, detect that the accumulation level threshold is exceeded. The first impression medium is therefore considered dirty. A flag may therefore be set to indicate that the impression medium is dirty. The user may then replace the impression medium with a clean impression medium. The controller may subsequently determine, based on second sensor data, a second accumulation level that does not meet the threshold. However, the previously set flag may still indicate that the impression medium is dirty. Based on this change, the controller may infer or deduce that the first impression medium has been replaced with a clean impression medium. The flag may then be updated to indicate that the impression medium is now clean.

Some example printers comprise one or more sensors positioned to detect if the printer has been accessed. For example, a sensor may detect that an opening has been accessed, where the opening provides access to the impression medium. If the opening has been accessed, it could be assumed that the impression medium has been replaced. By detecting that the opening has been accessed, as well as detecting that the accumulation level no longer meets the threshold, the controller may be able to determine with a greater level of certainty that the first impression medium has been replaced. Therefore, the controller can determine that the impression medium has been replaced, based at least in part on determining that the second accumulation level does not meet the threshold.

Now the impression medium has been replaced, there should be no, or minimal, printing fluid on the new impression medium. Based on this knowledge, sensor data recorded when the new impression medium has been replaced can be used to determine whether the image sensor 122 is clean. This exploits the fact that there should be little or no printing fluid on the clean impression medium, therefore any detected printing fluid would be fluid that is blocking the view of the image sensor 122.

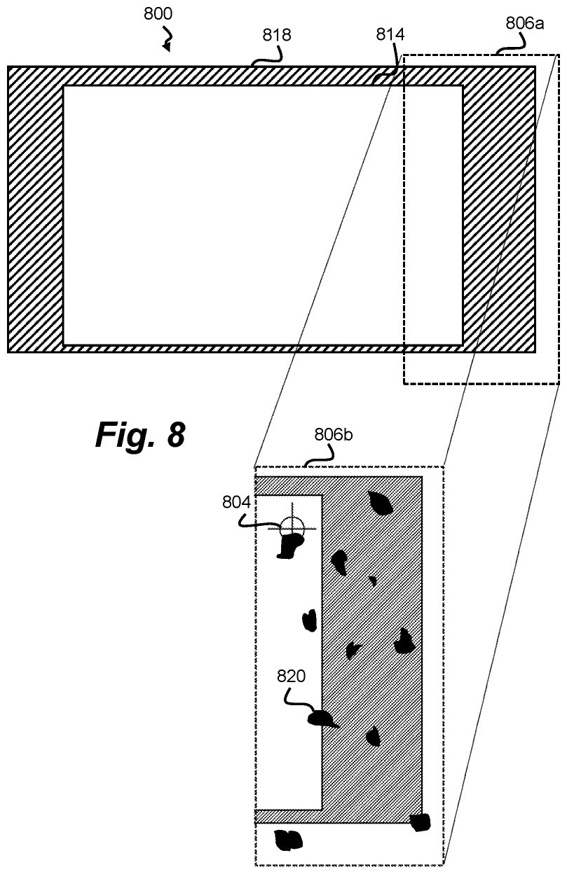

FIG. 8 depicts a clean impression medium 818 on the impression cylinder 116. A substrate 814 is received on the impression medium 818. The field of view 806a of the image sensor 122 shows little or no printing fluid deposited onto the impression medium 818. However, sensor data 808b corresponds to an image of the region 806a taken by the image sensor 122. Despite little or no printing fluid being present on the impression medium 818, the image 806b shows regions of printing fluid 820. The controller 124 may therefore inadvertently determine that printing fluid is present on the impression medium 818, when the impression medium 818 is in fact clean.

The printing fluid 820 is therefore not printing fluid present on the impression medium 818 but is instead printing fluid present between the image sensor 122 and the impression medium 818. For example, the printing fluid 820 may be present on a lens of the camera, or on another exposed, transparent surface positioned between the image sensor 122 and the impression medium 818. As mentioned above, the controller 124 will determine from the sensor data 806b that the accumulation level has now fallen below the threshold and will therefore conclude that the impression medium has been replaced. Using the same sensor data 806b, or sensor data taken shortly thereafter, and based on the knowledge that the impression medium has (recently) been replaced, the accumulation level can be determined and compared to a third threshold. For example, this third threshold may be a threshold above which the image 806b is said to be contaminated by printing fluid present on the exposed surface of the image sensor 122. For example, above this level it may be difficult to read any registration marks 804, and/or it may make it more difficult to accurately determine the accumulation level of printing fluid on the impression medium 818. In general, this third threshold is lower than the first threshold used to determine whether the impression medium is dirty.

In one example, the controller is configured to notify a user that an exposed surface of the image sensor should be cleaned responsive to determining that the second accumulation level meets a third threshold. As before, any known notification means may be used to notify a user to this effect. Notifying a user may comprise sending a user a notification with a particular indication.

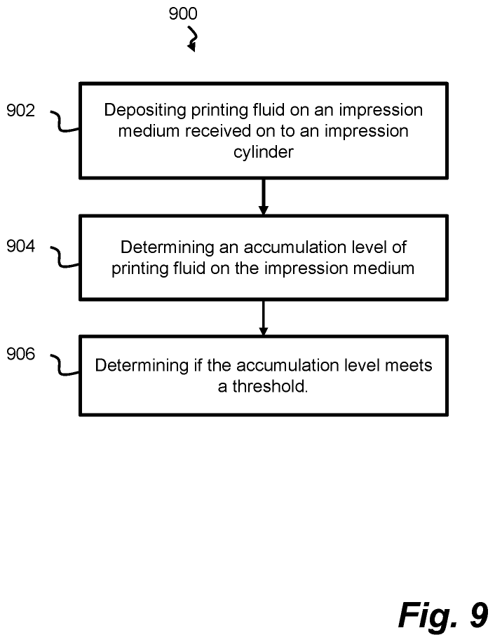

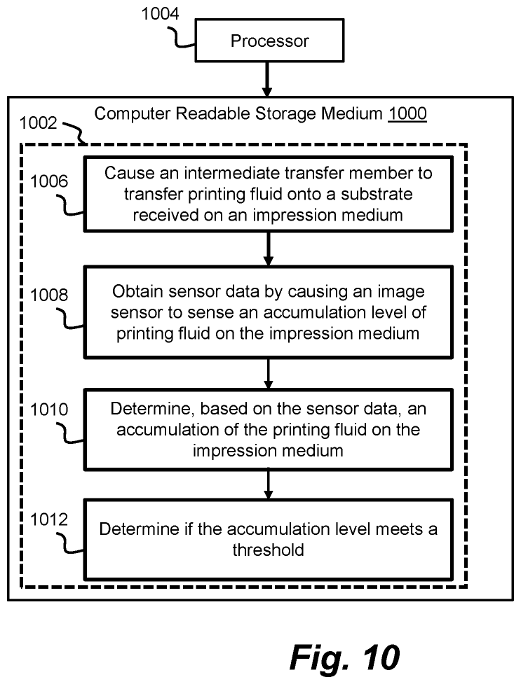

FIG. 9 is a flow diagram showing a method 900. The method can be performed by the printer 100. At block 902, the method comprises depositing printing fluid on an impression medium received on to an impression cylinder. At block 904, the method comprises determining an accumulation level of printing fluid on the impression medium. At block 906, the method comprises determining if the accumulation level meets a threshold.

In some examples, the method further comprises notifying a user that the impression medium should be replaced responsive to determining that the accumulation level meets the threshold.

In some examples, the method further comprises incrementing a count each time printing fluid is transferred to a substrate received on the impression medium and notifying a user that the impression medium should be replaced responsive to (i) determining that the accumulation level meets the threshold, and (ii) determining that the count meets a second threshold.

In some examples, the method further comprises notifying a user that the impression medium should be replaced responsive to determining that at least a portion of printing fluid has detached from the impression medium.

In some examples, the method further comprises determining that the accumulation level meets the threshold, determining a second accumulation level, and determining that the second accumulation level does not meet the threshold. The method may further comprise, based at least in part on determining that that the second accumulation level does not meet the threshold determining that the impression medium has been replaced.

Certain system components and methods described herein may be implemented by way of non-transitory computer program code that is storable on a non-transitory storage medium. In some examples, the controller 124 may comprise a non-transitory computer readable storage medium comprising a set of computer-readable instructions stored thereon. The controller 124 may further comprise one or more processors. In some examples, control may be split or distributed between two or more controllers 124 which implement all or parts of the methods described herein.

FIG. 10 shows an example of such a non-transitory computer-readable storage medium 1000 comprising a set of computer readable instructions 1002 which, when executed by at least one processor 1004, cause the processor(s) 1004 to perform a method according to examples described herein. The computer readable instructions 1002 may be retrieved from a machine-readable media, e.g. any media that can contain, store, or maintain programs and data for use by or in connection with an instruction execution system. In this case, machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc.

In an example, instructions 1002 cause the processor 1004, in a printer to, at block 1006, cause an intermediate transfer member to transfer printing fluid onto a substrate received on an impression medium. At block 1008, the instructions 1002 cause the processor 1004 to obtain sensor data by causing an image sensor to sense an accumulation level of printing fluid on the impression medium. At block 1010, the instructions 1002 cause the processor 1004 to determine, based on the sensor data, an accumulation level of the printing fluid on the impression medium. At block 1012, the instructions 1002 cause the processor 1004 to determine if the accumulation level meets a threshold.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A printer, comprising:
an impression cylinder arranged to receive an impression medium thereon;
an intermediate transfer member arranged to transfer printing fluid onto a substrate received on the impression medium;
an image sensor arranged to sense an accumulation of printing fluid on the impression medium as sensor data; and
a controller to:
determine, based on the sensor data, an accumulation level of the printing fluid on the impression medium; and
determine if the accumulation level meets a threshold.

2. A printer according to claim 1, wherein the controller is further to:
send a user a notification to indicate that the impression medium should be replaced, responsive to determining that the accumulation level meets the threshold.

3. A printer according to claim 1, wherein the controller is further to:
increment a count each time printing fluid is transferred from the intermediate transfer member to a substrate received on the impression medium; and
send a user a notification to indicate that the impression medium should be replaced, responsive to:
determining that the accumulation level meets the threshold; and
determining that the count meets a second threshold.

4. A printer according to claim 1, wherein the controller is further to:
send a user a notification to indicate that the impression medium should be replaced, responsive to:
determining, based on the sensor data, that at least a portion of printing fluid has detached from the impression medium.

5. A printer according to claim 4, wherein determining that at least a portion of printing fluid has detached from the impression medium comprises:
determining that the accumulation level is less than a previously determined accumulation level, the previously determined accumulation level corresponding to an accumulation level of printing fluid on the same impression medium at an earlier time.

6. A printer according to claim 4, wherein determining that at least a portion of printing fluid has detached from the impression medium comprises:
determining that the accumulation level of the printing fluid on the impression medium is non-uniform across a region of the impression medium.

7. A printer according to claim 1, wherein the controller is further to:
determine that the accumulation level meets the threshold;
receive second sensor data from the image sensor;
determine, based on the second sensor data, a second accumulation level;
determine that the second accumulation level does not meet the threshold; and
based at least in part on determining that that the second accumulation level does not meet the threshold:
determine that the impression medium has been replaced.

8. A printer according to claim 7, wherein the controller is further to:
send a user a notification to indicate that an exposed surface of the image sensor should be cleaned, responsive to determining that the second accumulation level meets a third threshold.

9. A printer according to claim 1, wherein the image sensor is a camera, and the camera is further arranged to sense one or more registration marks on the substrate.

10. A method of monitoring an impression medium, comprising:
depositing printing fluid on to an impression medium received on an impression cylinder;
determining an accumulation level of printing fluid on the impression medium; and
determining if the accumulation level meets a threshold.

11. A method according to claim 10, further comprising:
sending a user a notification to indicate that the impression medium should be replaced responsive to determining that the accumulation level meets the threshold.

12. A method according to claim 10, further comprising:
incrementing a count each time printing fluid is transferred to a substrate received on the impression medium; and
sending a user a notification to indicate that the impression medium should be replaced responsive to:
determining that the accumulation level meets the threshold; and
determining that the count meets a second threshold.

13. A method according to claim 10, further comprising:
sending a user a notification to indicate that the impression medium should be replaced responsive to:
determining that at least a portion of printing fluid has detached from the impression medium.

14. A method according to claim 10, further comprising:
determining that the accumulation level meets the threshold;
determining a second accumulation level;
determining that the second accumulation level does not meet the threshold; and
based at least in part on determining that that the second accumulation level does not meet the threshold:
determining that the impression medium has been replaced.

15. A non-transitory computer-readable storage medium storing instructions that, when executed by one or more processors in a printer, cause the one or more processors to:
cause an intermediate transfer member to transfer printing fluid onto a substrate received on an impression medium;
obtain sensor data by causing an image sensor to sense an accumulation of printing fluid on the impression medium;
determine, based on the sensor data, an accumulation level of the printing fluid on the impression medium; and
determine if the accumulation level meets a threshold.
